(19) United States
(12) Patent Application Publication
(10) Pub. No.: US 2006/0156772 A1
(43) Pub. Date: Jul. 20, 2006

(54) Sprayable organic fertilizer

(75) Inventors: Michael C. Karr, Monte Vista, CO (US); Leonard Krygsveld, Oliver (CA); Joseph W. Rundle, Westbank (CA); Derrick Rolfe, Toronto (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Bioz Agri Products Inc., Oliver (CA)

(21) Appl. No.: 11/300,351

(22) Filed: Dec. 15, 2005

Related U.S. Application Data
(60) Provisional application No. 60/635,941, filed on Dec. 15, 2004.

(51) Int. Cl. C05F 1/00

(52) U.S. Cl. 71/17

(57) ABSTRACT

This invention relates to a novel high nutrient containing organic fertilizer composition. More particularly, this invention relates to a high nutrient containing organic fertilizer which can be applied to vegetation in liquid form, for instance, in combination with water, by being sprayed through a hose-end type water sprayer. An organic fertilizer composition comprising: (a) a solid organic biomass which contains nitrogen, phosphorous and potassium; and (b) an osmotic attractant for water.

### REFERENCE TO RELATED APPLICATION

This application claims Convention priority on U.S. provisional patent application Ser. No. 60/635,941, filed 15 Dec. 2004.

### FIELD OF THE INVENTION

This invention relates to a novel high nutrient containing organic fertilizer composition. More particularly, this invention relates to a high nutrient containing organic fertilizer which can be applied to vegetation and soil in liquid form, for instance, in combination with water, by being sprayed through a hose-end type water sprayer.

### BACKGROUND OF THE INVENTION

Inorganic fertilizers are usually sold in concentrated solid form and applied to vegetation and soil in liquid form using water spray equipment such as hose-end sprayers. Because inorganic fertilizers are plant nutrient rich, being basically nitrogen, phosphorous and potassium compounds with no substantial impurities, they are effective as fertilizers even when applied in diluted form.

Organic or natural fertilizers are lower in plant nutrient content than inorganic fertilizers, chiefly because they contain non-nutrient organic matter (carbon, hydrogen and oxygen) that dilutes the plant nutrient content. The most important plant nutrients are nitrogen, phosphorus and potassium. Of these, the most important single element is nitrogen, which is present in biomass as proteins, which are comprised of carbon, hydrogen, oxygen and nitrogen molecules. Even so, if an organic nitrogen-containing biomass is purified so that it contains 100% protein, it still contains only 16% nitrogen, which is significantly less than inorganic fertilizers.

Organic fertilizers are manufactured or sold as solid materials and are intended for application on vegetation and soil in solid form. They are not usually intended to be applied in liquid form in association with a diluent such as water because the addition of the diluent or water reduces the plant nutrient concentration to unacceptable levels. Another difficulty is that ground biomass in solid form is highly absorbent and thus it absorbs a considerable amount of water before it becomes sufficiently fluid to be applied through conventional water spray equipment. Generally, a minimum of 3 parts water to one part biomass is required to convert solid ground biomass to a useable liquid. At present, the highest nitrogen-containing organic fertilizers are feather meal and blood meal, both of which contain up to 13% nitrogen. A 1 part fertilizer to 3 parts water dilution results in a material that is 3.25% nitrogen. This also assumes that no other nutrient containing materials (phosphorus, potassium, etc.) are added. The result is a fertilizer with a low analysis of 3-0-0. Accordingly, water diluted organic fertilizers inherently have a very low nutrient content.

Another problem with dry organic and/or natural fertilizers, even when applied to vegetation and soil in liquid form is that they cannot be used very well with a conventional hose-end type water sprayer. This is because they cannot pass through the sprayer without clumping, gumming, and/or clogging within the sprayer. A further complication is that dry organic or natural fertilizers that contain higher nitrogen values tend to be hydrophobic, that is, they repel water due to the protein and fat composition of the nitrogen containing materials.

There is, therefore, a strong need for a high nutrient value organic or natural fertilizer which can be applied in liquid form using a water sprayer without clogging the sprayer.

The following patents are relevant or of interest to the subject matter of the invention: U.S. Pat. Nos. 6,080,222; 5,876,479; 5,240,490; 6,254,654; 5,021,077; 4,328,024; 5,571,302; 5,888,938; 6,586,470; 5,705,455; 5,573,997; 4,676,196; 4,213,776; 6,379,413; 6,461,399; 6,383,245; 6,241,795; 6,159,262; 6,080,220; 5,443,613; 4,743,287; 6,264,714; 5,730,772; 6,254,656; 5,603,744; 5,478,373; 5,354,349.

### SUMMARY OF THE INVENTION

The invention is directed to an organic fertilizer composition comprising:

(a) a solid particulate organic biomass which contains nitrogen, phosphorous and potassium; and (b) an osmotic attractant for water.

The particulate organic biomass can be one or more components selected from the group consisting of bone meal, rock phosphate, blood meal and feather meal. The osmotic water attractant can be one or more components selected from the group consisting of magnesium sulphate, the double salt of potassium-magnesium sulphate and potassium sulphate. The organic biomass and osmotic attractant can be ground into particles of a mesh size of less than 100 mesh (149 microns).

The organic fertilizer can include oxidized lignite and attapulgite clay. The organic fertilizer can be comprised of magnesium sulphate, potassium sulphate, the double salt of potassium-magnesium sulphate (K₂SO₄, MgSO₄), bone meal, blood meal, oxidized lignite and attapulgite clay, ground into fine particles.

Rock phosphate can be included or can be substituted for bone meal. Feather meal can be included or can be substituted for blood meal.

In a specific embodiment, the invention is also directed to an organic fertilizer comprising: (a) 5% wt to 30% wt magnesium sulphate; (b) 7% wt to 30% wt potassium-magnesium sulphate; (c) 0% wt to 87% wt potassium sulphate; (d) 0% wt to 70% wt bone meal; (e) 0% wt to 70% wt rock phosphate; (f) 0% wt to 70% wt blood meal; (g) 0% wt to 70% wt feather meal, with the total adding up to 100%. The rationale of the wide ranges for the primary nutrients is that the nitrogen, phosphorous and potassium (N—P—K) ratios can be customized to fit varying formulation goals by potential distributors, or nutrient requirements by large farmers. The organic fertilizer optionally can include 0% wt to 30% wt oxidized lignite and 0% wt to 10% wt attapulgite clay.

The invention is also directed to a method of spraying an organic fertilizer on soil and vegetation which comprises placing an organic fertilizer having a fine particulate composition comprising magnesium sulphate, potassium sulphate, potassium-magnesium sulphate, bone meal, blood meal, oxidized lignite and attapulgite clay in a cannister of a hose-end sprayer, connecting the sprayer to a water hose, and passing water under pressure through the sprayer to dispense the organic fertilizer and water onto the soil and vegetation.

### DETAILED DESCRIPTION OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

This invention relates to a novel inventive fine particle high nutrient value organic fertilizer which can be passed through a water sprayer without clogging the sprayer, and without diminishing the plant nutrient concentration to unacceptable levels. The sprayable organic fertilizer powder according to the invention uses fine particle solid organic biomass as the plant nutrient and a high osmotic attractant which provides rapid wetting for extrusion of the mixture.

The solid material comprising the sprayable organic fertilizer according to the invention can be sprayed on soil and vegetation in liquid form through a hose-end type water sprayer, without clogging the sprayer, or caking or gumming the inside of the sprayer, and still retain a reasonably high level of plant nutrients. The organic fertilizer according to the invention has a much higher total analysis (sum of the nutrients) than a conventional liquid organic fertilizer. One formulation within the scope of the invention has an analysis of 8% nitrogen, 2% phosphorus and 8% potassium, with sulphur and magnesium as secondary nutrients.

Composition

The fertilizer according to the invention is comprised of magnesium sulphate, the double salt potassium-magnesium sulphate (K₂SO₄, MgSO₄), and optionally one of more of potassium sulphate, bone meal, rock phospate, blood meal, feather meal, oxidized lignite and attapulgite clay.

Acceptable ranges for the components of the organic fertilizer are as follows: (a) 5% wt to 30% wt magnesium sulphate; (b) 7% wt to 30% wt potassium-magnesium sulphate; (c) 0% wt to 87% wt potassium sulphate; (d) 0% wt to 70% wt bone meal; (e) 0% wt to 70% wt rock phosphate; (f) 0% wt to 70% wt blood meal; (g) 0% wt to 70% wt feather meal, the total adding up to 100%. The aim of the wide ranges for the primary nutrients (nitrogen, phosphorus and potassium) is so that ratios of the nutrients can be customized to fit varying formulation goals by potential distributors, or nutrient needs by large farmers.

The magnesium sulphate acts as an osmotic attractant for water and at the same time is a source of magnesium and sulphur. The potassium sulphate also acts as an osmotic attractant for water and is a source of potassium and sulphur. The double salt of potassium-magnesium sulphate is a source of potassium, magnesium and sulphur. The bone meal and/or rock phosphate acts as a source of phosphorus and calcium. The blood meal acts as a source of nitrogen. The feather meal acts as a source of nitrogen and calcium. The oxidized lignite helps to disperse the material and attracts water. The attapulgite clay helps to prevent caking of the mixture.

Process of Preparation

The materials according to the foregoing formulation are mixed and then ground to mesh sizes of <100 mesh (149 microns). This particle size enables water to easily penetrate the ground mixture and permits the fluidized mixture to pass through the exit orifice of a conventional hose-end water sprayer without clogging.

Process of Application

The organic fertilizer according to the invention is placed in dry fine particulate form in the cannister of a conventional hose-end water sprayer. The osmotic potential of the potassium and magnesium sulphates in the composition helps to hydrate the mixture uniformly and prevent gumming of the material, as water is mixed with the fertilizer inside the cannister of the sprayer. In this action, the magnesium sulphate is most effective. The potassium sulphate helps to a lesser extent, but is not sufficient without the magnesium sulphate. Although the presence of the oxidized lignite and the attapulgite clay is helpful, the presence of these two components is not critical to the success of the composition and the process.

The fine particulate organic fertilizer according to the invention can be packaged in one pound quantities. The process of application on vegetation and soil is relatively rapid because one pound of the fine particulate dry organic fertilizer material can be sprayed from a hose-end sprayer, such as that sold in the market-place under the trademark Miracle Gro, or a similar consumer-type hose-end sprayer, within 25 minutes. Larger size sprayers can also be used to apply the materials (in terms of pounds applied per minute) more rapidly, if that is required.

Early trials of the fine particulate organic fertilizer according to the invention involved the use of feather meal instead of blood meal, and potassium sulphate as the sole osmotic agent. These early trials were successful but were not successful for practical purposes because the time required to spray all of the material out of the cannister was excessive, and some gumming of the material inside the sprayer occurred. When magnesium sulphate was added to the composition, performance improved and the fine particulate material was readily sprayed out of the cannister. However, some shaking of the material in the cannister was needed to dispense all of the material from the sprayer. When finely ground blood meal was substituted for feather meal, it was found that no shaking was necessary, and the entire material was extruded in less than 30 minutes.

The following organic fertilizer formulation was tested with good results:

| | | |
|---|---|---|
| Blood meal | 61.5% | wt |
| Bone meal | 8% | wt |
| Potassium sulphate | 17% | wt |
| Attapulgite clay | 0.5% | wt |
| Magnesium sulphate (Epsom salts) | 13% | wt |

Analysis of the formulation was 8% N, 2% P₂O₅ and 8% K₂O, that is, (8-2-8).

The Excel spreadsheet developed from the trial test was as follows:

### EXAMPLE

| | A | B | C | D | D | F |
|---|---|---|---|---|---|---|
| 1 | Sprayable Organic Fertilizer Time Sheet | | | | | |
| 2 | | | | | | |
| 3 | | | PSI @ Source | 50 lbs psi | 55 lbs psi | 60 lbs psi |
| 4 | | | PSI @ Hose | 33 lbs psi | 37 lbs psi | 40 lbs psi |
| 5 | | | | | | |
| 6 | | | Quantity grams | TIME/MINUTES | | |
| 7 | SPRAYERS | Miracle Gro | 455 | 28 | 28 | 27 |
| 8 | | | | | | |
| 9 | | 24 oz Non Clo | 500 | 15 | 13 | 13 |
| 10 | | | | | | |
| 11 | | 32 oz Non Clo | 700 | 25 | 22 | 22 |

| | |
|---|---|
| 12 | |
| 13 | Standard garden hose - length 50 ft @ 5/8″ dia. |
| 14 | Note: Non Clog Sprayers do not have attached “shower head”. |
| 15 | Miracle Gro sprayer has attached “shower head” which reduces spray out time. |
| 16 | Materials in fertilizer derived from 100% natural organic materials. |

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An organic fertilizer composition comprising:
(a) a solid particulate organic biomass which contains nitrogen, phosphorous and potassium; and
(b) an osmotic attractant for water.

2. An organic fertilizer as claimed in claim 1 wherein the organic biomass is one or more components selected from the group consisting of bone meal, rock phosphate, blood meal and feather meal.

3. An organic fertilizer as claimed in claim 1 wherein the osmotic water attractant is one or more components selected from the group consisting of magnesium sulphate, the double salt of potassium-magnesium sulphate, and potassium sulphate.

4. An organic fertilizer as claimed in claim 2 wherein the osmotic water attractant is one or more components selected from the group consisting of magnesium sulphate, the double salt of potassium-magnesium sulphate, and potassium sulphate.

5. An organic fertilizer as claimed in claim 1 wherein the organic biomass and osmotic attractant are ground to a mesh size of less than 100 mesh (149 microns).

6. An organic fertilizer as claimed in claim 2 wherein the organic biomass and osmotic attractant are ground to a mesh size of less than 100 mesh (149 microns).

7. An organic fertilizer as claimed in claim 2 including oxidized lignite and attapulgite clay.

8. An organic fertilizer as claimed in claim 3 including oxidized lignite and attapulgite clay.

9. An organic fertilizer comprising magnesium sulphate, potassium-magnesium sulphate, bone meal, blood meal, oxidized lignite and attapulgite clay.

10. An organic fertilizer as claimed in claim 9 wherein rock phosphate is substituted for bone meal.

11. An organic fertilizer as claimed in claim 9 wherein feather meal is substituted for blood meal.

12. A particulate organic fertilizer comprising:
(a) 5% wt to 30% wt magnesium sulphate;
(b) 7% wt to 30% wt potassium-magnesium sulphate;
(c) 0% wt to 87% wt potassium sulphate;
(d) 0% wt to 70% wt bone meal;
(e) 0% wt to 87% wt potassium sulphate;
(f) 0% wt to 70% wt blood meal; and
(g) 0% wt to 70% wt feather meal,
the total adding up to 100%.

13. An organic fertilizer as claimed in claim 12 wherein potassium sulphate is included, rock phosphate is substituted for bone meal, and feather meal is substituted for blood meal.

14. An organic fertilizer as claimed in claim 12 including 0% wt to 30% wt oxidized lignite and 0% wt to 10% wt attapulgite clay.

15. An organic fertilizer as claimed in claim 13 including 0% wt to 30% wt oxidized lignite and 0% wt to 10% wt attapulgite clay.

16. A method of spraying an organic fertilizer on soil and vegetation which comprises placing a particulate organic fertilizer having a composition comprising magnesium sulphate, potassium sulphate, bone meal, blood meal, oxidized lignite and attapulgite clay and a mesh size of less than 100 mesh in a cannister of a hose-end sprayer, connecting the sprayer to a water hose, and passing water under pressure through the sprayer to dispense the organic fertilizer and water onto the soil and vegetation.
